(19) United States
(12) Patent Application Publication
(10) Pub. No.: US 2017/0041283 A1
(43) Pub. Date: Feb. 9, 2017

(54) PRIORITIZING AND HANDLING OF MESSAGES ACROSS MULTIPLE COMMUNICATION SYSTEMS

(71) Applicant: INTERNATIONAL BUSINESS MACHINES CORPORATION, ARMONK, NY (US)

(72) Inventors: SHANG Q. GUO, CORTLANDT MANOR, NY (US); JONATHAN LENCHNER, NORTH SALEM, NY (US); MAHARAJ MUKHERJEE, POUGHKEEPSIE, NY (US)

(21) Appl. No.: 14/967,410

(22) Filed: Dec. 14, 2015

Related U.S. Application Data
(63) Continuation of application No. 14/817,412, filed on Aug. 4, 2015.

(51) Int. Cl. H04L 12/58

(52) U.S. Cl. CPC H04L 51/36; H04L 51/26

(57) ABSTRACT

Embodiments include method, systems and computer program products for handling messages across multiple communication systems. Aspects include monitoring, by a processor, interactions of an individual with one or more messaging systems via one or more communication devices and determining a preference and a priority of the individual based on the interactions. Aspects also include receiving a message via the one or more messaging systems and delivering the message to a desired communication device selected from the one or more communication devices via a desired communication system selected from the one or more communication systems. The desired communication device and the desired communication device are selected based on the preference and the priority of the individual.

### DOMESTIC PRIORITY

This application is a continuation of U.S. patent application Ser. No. 14/817,412, filed Aug. 4, 2015, the disclosure of which is incorporated by reference herein in its entirety.

### BACKGROUND

The present disclosure relates to delivery of messages across multiple communication systems and more specifically, to methods, systems and computer program products for prioritizing and handling messages across multiple communication systems.

In today's society, individuals often utilize a variety of different ways to communicate with one another, such as telephone calls or messages via landline phones, cellular phones, or voice over Internet protocol (VoIP) phones, text messages, email, instant messages, social network postings and messages. In addition, individuals may have a number of cell phones, email accounts, and often many social network pages. This proliferation of communication options makes it easy for an individual to not receive important messages in a timely manner or to miss important messages.

Everyone has their own preference as to which form of communication they like to read or use, and which they prioritize over the other forms of communication. For example, some individuals rarely check the voice messages on their VoIP phone or their answering machines because they often largely contain junk calls. Each individual's communication preferences can be different, and a given person's friends and family may have different communication preferences still. For example, some individuals believe that texting is the best communication medium for important messages, whereas others believe voice calls and voice messages are the best communication medium for important messages. Often these differences in communication preferences, and implicit assumptions about another person's communication preferences, can lead to delays in receiving and responding to messages. These delays can cause some users to feel slighted or ignored.

### SUMMARY

In accordance with an embodiment, a method for handling messages across multiple communication systems is provided. The method includes monitoring, by a processor, interactions of an individual with one or more messaging systems via one or more communication devices and determining preferences and priorities of the individual based on the interactions. The method also includes receiving a message via the one or more messaging systems and delivering the message to a desired communication device selected from the one or more communication devices via a desired communication system selected from the one or more communication systems. The desired communication device and the desired communication system are selected based on the preferences and the priorities of the individual.

In accordance with another embodiment, a unified messaging system for handling messages across multiple communication systems includes a processor in communication with one or more types of memory. The processor is configured to monitor interactions of an individual with one or more messaging systems via one or more communication devices and to determine a preference and a priority of the individual based on the interactions. The processor is also configured to receive a message via the one or more messaging systems and to deliver the message to a desired communication device selected from the one or more communication devices via a desired communication system selected from the one or more communication systems. The desired communication device and the desired communication system are selected based on the preferences and the priorities of the individual.

In accordance with a further embodiment, a computer program product for handling messages across multiple communication systems includes a non-transitory storage medium readable by a processing circuit and storing instructions for execution by the processing circuit for performing a method. The method includes monitoring interactions of an individual with one or more messaging systems via one or more communication devices and determining preferences and priorities of the individual based on the interactions. The method also includes receiving a message via the one or more messaging systems and delivering the message to a desired communication device selected from the one or more communication devices via a desired communication system selected from the one or more communication systems. The desired communication device and the desired communication system are selected based on the preferences and the priorities of the individual.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a cloud computing environment according to an embodiment of the present invention;

FIG. 2 depicts abstraction model layers according to an embodiment of the present invention;

FIG. 3 is a block diagram illustrating one example of a processing system for practice of the teachings herein;

FIG. 4 is a block diagram illustrating a messaging system in accordance with an exemplary embodiment;

FIG. 5 is a flow diagram of a method for handling messages across multiple communication systems in accordance with an exemplary embodiment; and

FIG. 6 is a flow diagram of another method for handling messages across multiple communication systems in accordance with an exemplary embodiment.

### DETAILED DESCRIPTION

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

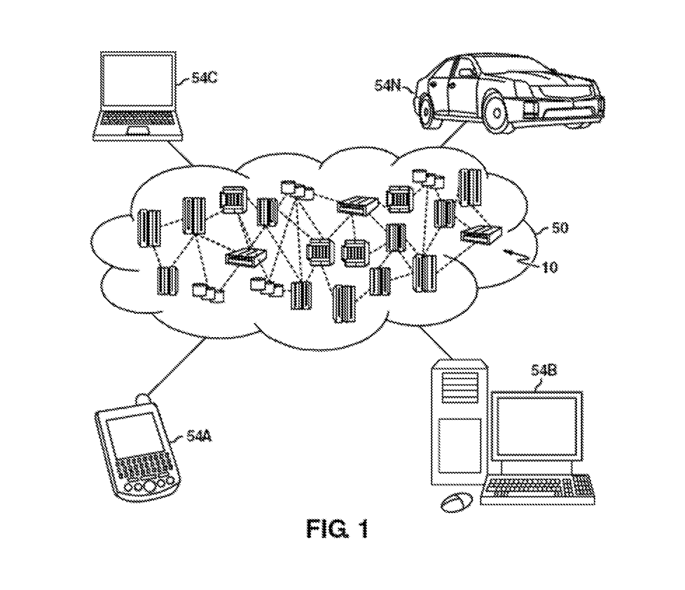

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

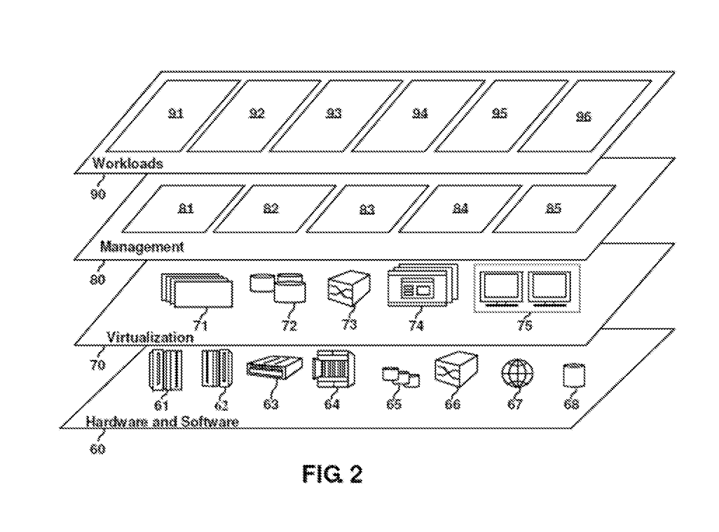

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and processing of messages across multiple communication systems 96.

In accordance with exemplary embodiments of the disclosure, methods, systems and computer program products for handling messages across multiple communication systems are provided. In exemplary embodiments, a unified messaging system is configured to receive messages for an individual across multiple communication systems utilized by the individual. The unified messaging system is also configured to receive information from available sensors in communication devices used by the individual, to obtain information about an individual's current context, i.e., what device and system they are currently utilizing (if any), what devices they have on their person or are close to, where they are situated and what other recognizable entities are in their vicinity. In exemplary embodiments, the unified messaging system observes the individual's use of each of their communication devices and systems and responsively learns the individual's priorities and preferences regarding what sorts of messages they prefer to receive, read and respond to and on what communication device/system they prefer to use. Based on the individual's priorities and preferences, the unified messaging system prioritizes the messages received and delivers the messages to a desired communication device via a desired messaging system.

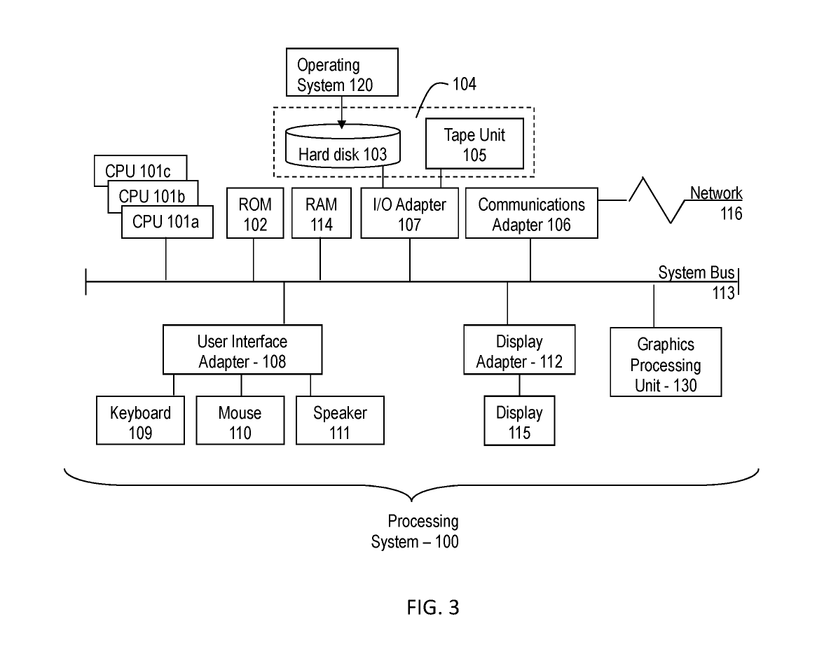

Referring to FIG. 3, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 3 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing, and has a highly parallel structure that makes it more effective than general-purpose CPUs for algorithms where processing of large blocks of data is done in parallel.

Thus, as configured in FIG. 3, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system such as the AIX® operating system from IBM Corporation to coordinate the functions of the various components shown in FIG. 3.

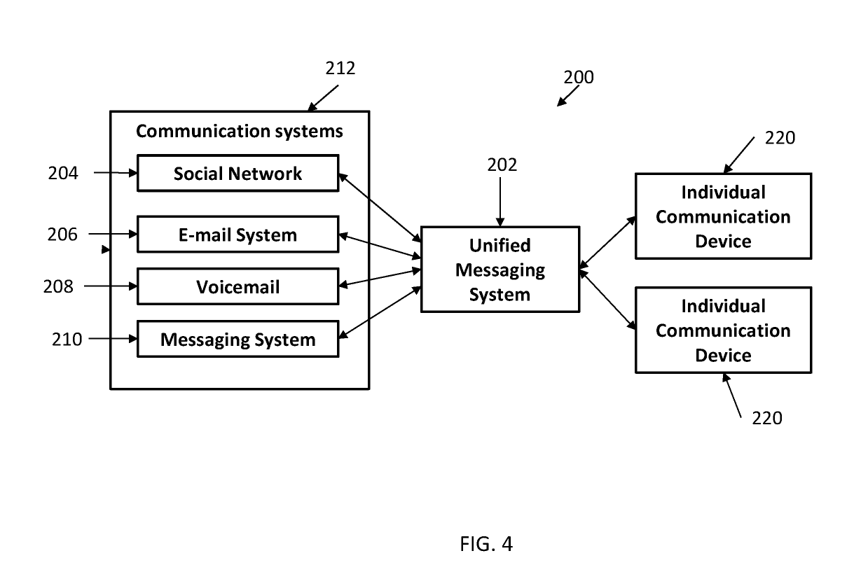

Referring now to FIG. 4, a system 200 for handling messages across multiple communication systems is illustrated. As illustrated, the system 200 includes a unified messaging system 202 that is in communication with one or more individual communication devices 220. The individual communication devices 220 may include cell phones, computers, tablets, landline phones, smart watches and any other suitable device that an individual may use to send or receive messages. In addition, the unified messaging system 202 is in communication with multiple communication systems 212. These communication systems 212 may include, but are not limited to, social networks 204, email systems 206, voicemail systems 208, messaging systems 210, and other communication systems. In exemplary embodiments, the unified messaging system 202 can be centralized, as illustrated in FIG. 4, it can be distributed among various communication systems 212 and devices 220, or it may contain both a central portion and a distributed portion.

In exemplary embodiments, the unified messaging system 200 is configured to receive messages for an individual across a plurality of communication systems 212 utilized by the individual. The unified messaging system 200 is also configured to receive information from available sensors in the individual communication devices 220, to obtain information about an individual's context. The context includes what communication device 220 and communication system 212 the individual is currently utilizing (if any), what communication devices 220 are in their vicinity, where the individual is located and/or what other recognizable entities are in their vicinity. In exemplary embodiments, the unified messaging system 200 is configured to observe the individual's use of each of their communication devices 220 and communication systems 212 and to learn from the individual's interactions with the communication systems 212 and communication devices 220. The unified messaging system 200 learns what messages are of the most interest for individuals to respond to by identifying patterns of previous responses.

Based on these observations, the unified messaging system 200 responsively learns the individual's priorities and preferences regarding what types of messages they prefer to read and respond to. In exemplary embodiments, the individual's priorities and preferences regarding what sorts of messages they prefer to read and respond to are dynamic and may change over time. For example, the individual may install a new messaging application on their cell phone and start using it exclusively for receiving messages. Accordingly, the unified messaging system 200 continuously observes the individual's use of each of their communication devices 220 and communication system 212 and updates the individual's priorities and preferences. The individual's priorities are used to determine the order in which received messages should be delivered to the individual while the individual's preferences are used to determine the manner, i.e., which communication device and communication system, that should be used to deliver the message to the individual.

In exemplary embodiments, the unified messaging system 200 receives messages from each of the communication systems 212, prioritizes the messages received and delivers the messages to a desired communication device 220 via a desired communication system 212 based on the individual's priorities and preferences. In exemplary embodiments, the unified messaging system 200 may also be configured to delete messages that have been received that have an importance that is determined to be below a threshold level, e.g., spam messages or advertisements. In exemplary embodiments, the unified messaging system 200 is configured to monitor an individual's context and to opportunistically dispatch queued messages to the individual when the individual's is observed to be idle or in a position to likely be able to process such messages.

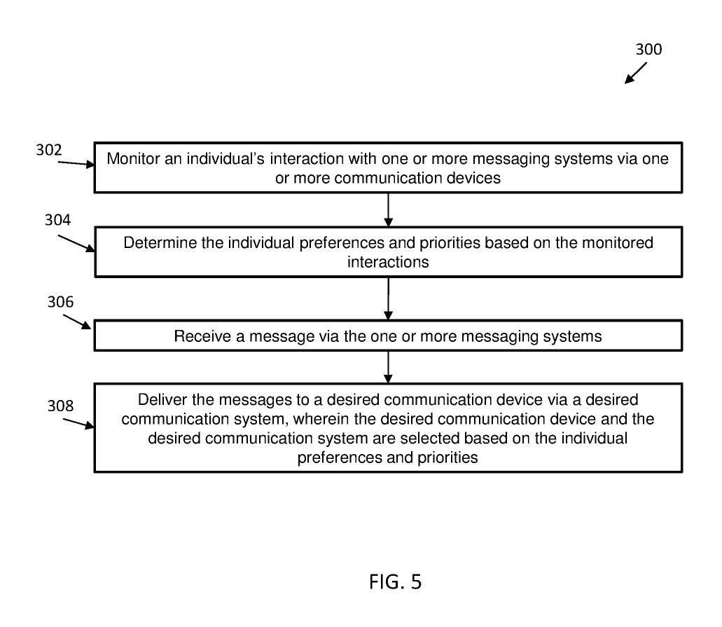

Referring now to FIG. 5, a flow diagram of a method 300 for handling messages across multiple communication systems in accordance with an exemplary embodiment is shown. As shown at block 302, the method 300 includes monitoring an individual's interaction with one or more messaging systems via one or more communication devices. Next, as shown at block 304, the method 300 includes determining the individual's preferences and priorities based on the monitored interactions. The method 300 also includes receiving a message via the one or more messaging systems, as shown at block 306. Next, as shown at block 308, the method 300 includes delivering the message to a desired communication device via a desired communication system, wherein the desired communication device and the desired communication system are selected based on the individual's preferences and priorities.

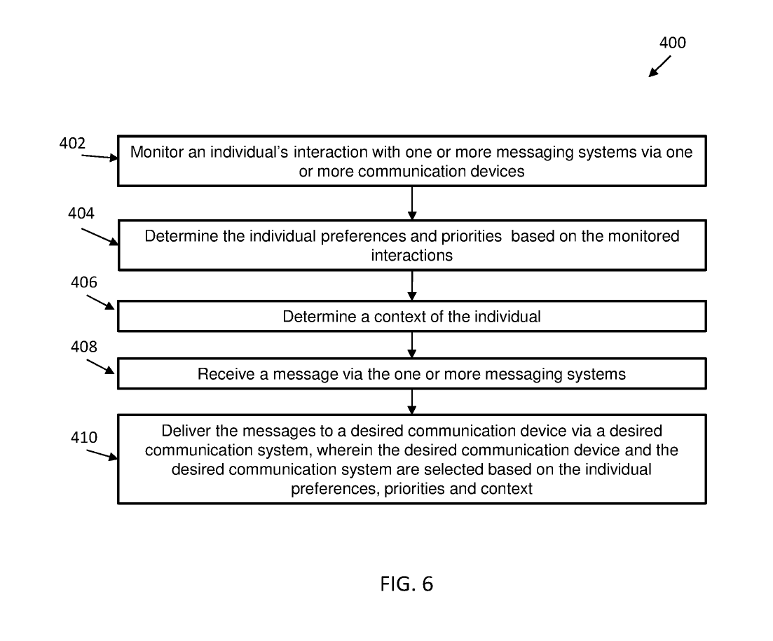

Referring now to FIG. 6, a flow diagram of another method 400 for handling messages across multiple communication systems in accordance with an exemplary embodiment is shown. As shown at block 402, the method 400 includes monitoring an individual's interaction with one or more messaging systems via one or more communication devices. Next, as shown at block 404, the method 400 includes determining the individual's preferences and priorities based on the monitored interactions. The method 400 also includes determining a context of the individual, as shown at block 406. The context may include what communication device and communication system the individual is currently utilizing (if any), what communication devices are in their vicinity and where the individual is located. In exemplary embodiments, the context of the individual may be based on the individual's interaction with one or more messaging systems via one or more communication devices and/or based on the input from one or more sensors disposed in the one or more communication devices.

Continuing with reference to FIG. 6, as shown at block 408, the method 400 includes receiving a message via the one or more messaging systems. The method 400 includes delivering the message to the a desired communication device via a desired communication system, wherein the desired communication device and desired communication system are selected based on the individual preferences, priorities and context, as shown at block 410.

In exemplary embodiments, the unified messaging system monitors an individual's behavior and learns what the individual's preferences are regarding what communication device the individual likes to use and when. Based on the learned preferences, the unified messaging system ensures that important messages are delivered to the individual through the desired communication system so the message gets the individual's attention. For example, if an individual's wife (highest priority) texts the individual's on their cell phone and the unified messaging system knows that the user is currently using a social networking application and that the user does not frequently check their texts on their cell phone, the unified messaging system will receive the text message on the cell phone and will create and deliver an instant message on the social networking application with the content of the text message.

In exemplary embodiments, the unified messaging system is configured to monitor the context of individuals that are using the unified messaging system. In exemplary embodiments, the context of the individual includes where the individual is in a figurative, online sense at any given time. For example, the unified messaging system may know that the individual just used their smartphone, or that the individual just sent an email from their personal email account, or that the individual just left a comment on their social networking application, or the like. Accordingly, when an urgent message is received, the unified messaging system will deliver the message to the place where the individual is, so that the individual can see it right away. If a non-urgent message is received, the unified messaging system may be configured to deliver the message in a less urgent fashion, e.g., using a medium that the individual typically uses for non-urgent messages.

One problem with traditional systems for combining multiple messaging systems into a single inbox is that the individual can become overwhelmed by the large number of messages. In exemplary embodiments, the unified messaging system is configured to prioritize messages based on one or more of the sender, the subject of messages, when this subject of the message was last referenced by the individual, whether a given person is mentioned by name in the body of the message, and whether or not the message seems to contain an imbedded To Do item. In one embodiment, the unified messaging system is configured to learn from user interactions, such as past communications, to know whether the message is urgent. For example, if the individual always replies a certain type of messages, such as messages that contain certain keywords, the system will deliver the message with a higher priority. In exemplary embodiments, the unified messaging system is configured to save messages that are of lower importance and only deliver these low priority messages, e.g., after working hours, as opposed to in the middle of the day.

Preferences and priorities can be learned using had crafted features or by learning features via various machine learning techniques that are known in the art. It is simple enough to learn a given user's overall preferred method for communication by direct observation of usage frequency. Moreover, it is not hard to discover with some precision what constitutes a given user's friends and family, by monitoring the user's social media postings. The system can therefore discern between a user's preferred method of communicating when the communication partner is a friend and family member, or someone else. Many users have a preferred method of communication for friends and family, and a different preferred method of communication for everyone else. Prominent user contexts include, “at home,” “at work,” “while driving,” “on a laptop,” “on a tablet,” “on a phone,” “on no particular device.” Note that a user can be in more than one user context at a time. For example, if it can be recognized that a user is at the mall, and so there is a state for “at the mall” then the user can be in that context as well as one of the contexts “on a laptop,” “on a tablet,” “on a phone,” or “on no particular device.” There are various indicators that a given user is at work, for example that the time is during normal working hours, that a majority of answered email are not from friends and family, and so on. Thus some contexts are obvious and can be determined directly, while others must be learned and the conclusion that a given user is in the given context is not one hundred percent certain. Nonetheless, given a certain confidence that the user is in a given context, the system can learn the user's preferences, given the context, simply by computing (and multiplying) conditional probabilities.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for handling messages across multiple communication systems, the method comprising:
monitoring, by a processor, interactions of an individual with one or more messaging systems via one or more communication devices;
determining one or more of a preference and a priority of the individual based on the interactions;
receiving a message via the one or more messaging systems; and
delivering the message to a desired communication device selected from the one or more communication devices via a desired communication system selected from the one or more communication systems, wherein the desired communication devices and the desired communication system are selected based on the one or more of the preference and the priority of the individual.

2. The method of claim 1, further comprising determining a context of the individual based on the interactions.

3. The method of claim 2, wherein the selection of the desired communication device and the desired communication system are further based on the context of the individual.

4. The method of claim 2, wherein the context of the individual includes one or more of: an identification of the one or more communication devices that the individual most recently used; an identification of the one or more communication systems the individual most recently used; an identification of the one or more communication devices that are in a vicinity of the individual; and a geographical location of the individual.

5. The method of claim 1, wherein determining the one or more of the preference and the priority of the individual based on the interactions includes performing a machine learning algorithm on the interactions.

6. The method of claim 1, wherein the priority is used to determine an order in which received messages will be delivered to the individual.

7. The method of claim 1, wherein the one or more of the preference and the priority are used to determine a manner in which received messages will be delivered to the individual.
